(19) United States
(12) Patent Application Publication
(10) Pub. No.: US 2015/0188476 A1
(43) Pub. Date: Jul. 2, 2015

(54) MOTOR DRIVING APPARATUS AND METHOD, AND VOICE COIL MOTOR SYSTEM USING THE SAME

(71) Applicant: SAMSUNG ELECTRO-MECHANICS CO., LTD,, Suwon-Si (KR)

(72) Inventor: Wan Cheol Yang, Suwon-Si (KR)

(73) Assignee: SAMSUNG ELECTRO-MECHANICS CO., LTD,, Suwon-Si (KR)

(21) Appl. No.: 14/226,350

(22) Filed: Mar. 26, 2014

(30) Foreign Application Priority Data
Dec. 30, 2013 (KR) 10-2013-0166740

(51) Int. Cl. H02P 23/04

(52) U.S. Cl. CPC H02P 23/04

(57) ABSTRACT

A motor driving apparatus may include: a weight generating unit generating weights of external input signals using a damping ratio of a motor apparatus; and a driving signal generating unit generating a driving signal by converting values of at least some signals among the external input signals to 0 using the weights.

### CROSS-REFERENCE TO RELATED APPLICATION

This application claims the benefit of Korean Patent Application No. 10-2013-0166740 filed on Dec. 30, 2013, with the Korean Intellectual Property Office, the disclosure of which is incorporated herein by reference.

### BACKGROUND

The present disclosure relates to a motor driving apparatus and method, and a voice coil motor system using the same.

Auto-focusing technology, technology allowing for the focusing of a lens through a lens being automatically moved by a predetermined amount using an electric motor, a piezoelectric element, or the like, has been applied to cameras, smartphone camera modules, and the like.

In auto-focusing technology, a lens is focused by sensing a distance to an imaging object and then moving the lens to a position at which an optimal image is formed by an auto-focusing algorithm using an image output signal from a sensor.

In order to perform auto-focusing, a motor, that is, an actuator, is required. Actuators can be classified as stepping motor (SM) type actuators, piezoelectric type actuators, voice coil motor (VCM) type actuators, and others, depending on a driving scheme employed therein.

Among such actuators, the voice coil motor type actuator has been used in mobile devices, in which miniaturization is important, such as cellular phones. That is, such a voice coil motor is driven to move a lens, such that auto-focusing, for focusing a camera lens on a specific subject, may be performed.

A general voice coil motor may not satisfy a requirement for miniaturization in the case of a closed loop control. Therefore, a scheme of controlling a voice coil motor is generally implemented with an open loop.

However, in the case of controlling the voice coil motor with such an open loop, a unique resonance phenomenon may occur therein. Such a resonance phenomenon may cause a ringing phenomenon at the time of driving a voice coil motor, thereby having an effect on an auto-focusing function of a camera or causing malfunctioning thereof.

### SUMMARY

An exemplary embodiment in the present disclosure may provide a motor driving apparatus and method capable of more precisely controlling the driving of a voice coil motor by generating a driving signal through reflection of a weight using a damping ratio of a motor apparatus to prevent a resonance phenomenon occurring in the voice coil motor and a ringing phenomenon due to the resonance phenomenon, and a voice coil motor system using the same.

According to an exemplary embodiment in the present disclosure, a motor driving apparatus may include: a weight generating unit generating weights of external input signals using a damping ratio of a motor apparatus; and a driving signal generating unit generating a driving signal by converting values of at least some signals among the external input signals to 0 using the weights.

The weight generating unit may calculate the weight α using the following Equation:

α=p(1)*zeta³+p(2)*zeta²+p(3)*zeta+p(4)

where zeta is the damping ratio, and p(1) to p(4) indicate fitting coefficients.

The driving signal may include a first signal outputting a first value until a first time, a second signal outputting 0 from the first time to a second time, and a third signal outputting the first value after the second time.

The driving signal generating unit may include: a timing controller determining output timing of the second signal using the weight provided from the weight generating unit; and a selector outputting the driving signal including the first to third signals based on controlling by the timing controller.

The timing controller may reflect the weight at a point in time corresponding to ⅙ of a resonance period of the motor apparatus to determine the first time and may determine a point in time corresponding to ⅓ of the resonance period of the motor apparatus to be the second time.

The motor driving apparatus may further include a filter unit low-pass-filtering the driving signal output from the driving signal generating unit.

The external input signal and the driving signal may be digital signals, and the motor driving apparatus may further include a digital-to-analog converting unit performing digital-to-analog conversion on the driving signal and providing the converted signal to the motor apparatus.

According to an exemplary embodiment in the present disclosure, a voice coil motor system may include: a voice coil motor apparatus; and a motor driving apparatus generating a driving signal using a damping ratio of the voice coil motor apparatus, wherein the driving signal is generated by converting values of at least some of external input signals to 0 using weights generated using the damping ratio.

The motor driving apparatus may include: a weight generating unit generating the weights of the external input signals using the damping ratio; and a driving signal generating unit generating the driving signal by converting values of at least some signals among the external input signals to 0 using the weights.

The weight generating unit may calculate the weight α using the following Equation:

α=p(1)*zeta³+p(2)*zeta²+p(3)*zeta+p(4)

where zeta is the damping ratio, and p(1) to p(4) indicate fitting coefficients.

The driving signal may include a first signal outputting a first value until a first time, a second signal outputting 0 from the first time to a second time, and a third signal outputting the first value after the second time.

The driving signal generating unit may include: a timing controller determining output timing of the second signal using the weight provided from the weight generating unit; and a selector outputting the driving signal including the first to third signals based on controlling by the timing controller.

The timing controller may reflect the weight at a point in time corresponding to ⅙ of a resonance period of the voice coil motor apparatus to determine the first time and may determine a point in time corresponding to ⅓ of the resonance period of the voice coil motor apparatus to be the second time.

According to an exemplary embodiment in the present disclosure, a motor driving method performed by a motor driving apparatus for driving a motor apparatus may include: generating weights of external input signals using a damping ratio of the motor apparatus; and generating a driving signal by converting values of at least some signals among the external input signals to 0 using the weights.

The driving signal may include a first signal outputting a first value until a first time, a second signal outputting 0 from the first time to a second time, and a third signal outputting the first value after the second time.

In the generating of the weights, the weight α may be calculated using the following Equation:

α=p(1)*zeta³+p(2)*zeta²+p(3)*zeta+p(4)

where zeta is the damping ratio, and p(1) to p(4) indicate fitting coefficients.

The generating of the driving signal may include: reflecting the weight at a point in time corresponding to ⅙ of a resonance period of the motor apparatus to determine the first time and determining a point in time corresponding to ⅓ of the resonance period of the motor apparatus to be the second time; outputting a value corresponding to the external input signal until the first time; outputting 0 from the first time to the second time; and outputting the value corresponding to the external input signal after the second time.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a reference diagram showing a general unit step signal;

FIG. 2 is a reference diagram showing a general unit gate signal;

FIG. 3 is a reference diagram showing an example of a combined pulse signal;

FIG. 4 is a graph showing a change amount of residual vibrations depending on a change in a damping ratio and a weight of a pulse width;

FIG. 5 is a reference diagram showing a change in a weight to a damping ratio given in FIG. 4;

FIG. 6 is a configuration diagram showing an example of a voice coil motor system according to an exemplary embodiment of the present disclosure;

FIG. 7 is a reference diagram showing an example of a driving signal output from a driving signal generating unit of FIG. 6;

FIG. 8 is a reference diagram for describing an operation of a timing controller;

FIG. 9 is a reference diagram showing an example of a filter unit of FIG. 6;

FIGS. 10 and 11 are reference graphs showing a vibration error according to the related art;

FIG. 12 is a reference graph showing a vibration error according to an exemplary embodiment of the present disclosure; and

FIG. 13 is a flow chart for describing an example of a motor driving method according to an exemplary embodiment of the present disclosure.

### DETAILED DESCRIPTION

Exemplary embodiments of the present disclosure will now be described in detail with reference to the accompanying drawings.

In addition, hereinafter, a motor apparatus itself will be called a motor apparatus, and a system including a motor driving apparatus for driving the motor apparatus and the motor apparatus will be called a motor system.

Hereinafter, a transfer function of a voice coil motor according to an exemplary embodiment of the present disclosure will be described. The following description may be applied to a weight generating unit and a driving signal generating unit to be described below.

The transfer function of the voice coil motor, which is a 2nd order dynamic system, may be mathematically modeled as represented by Mathematical Equation 1.

$$G ( s ) = \frac{Y ( s )}{U ( s )} = \frac{{ω}_{n}^{2}}{{s}^{2} + 2 ζ {ω}_{n} s + {ω}_{n}^{2}} \qquad [ Mathematical Equation 1 ]$$

Here, ωₙ is a natural frequency, and ζ is a damping ratio.

In a damped case (0<ζ<1), a transfer function has a complex pole as represented by Mathematical Equation 2.

$$\frac{Y ( s )}{U ( s )} = \frac{{ω}_{n}^{2}}{( s + ζ {ω}_{n} + j {ω}_{d} ) ( s + {ζω}_{n} - j {ω}_{d} )} \qquad [ Mathematical Equation 2 ]$$

Here, ω_{d}=ωₛ\sqrt{1−ζ²} is a damped natural frequency.

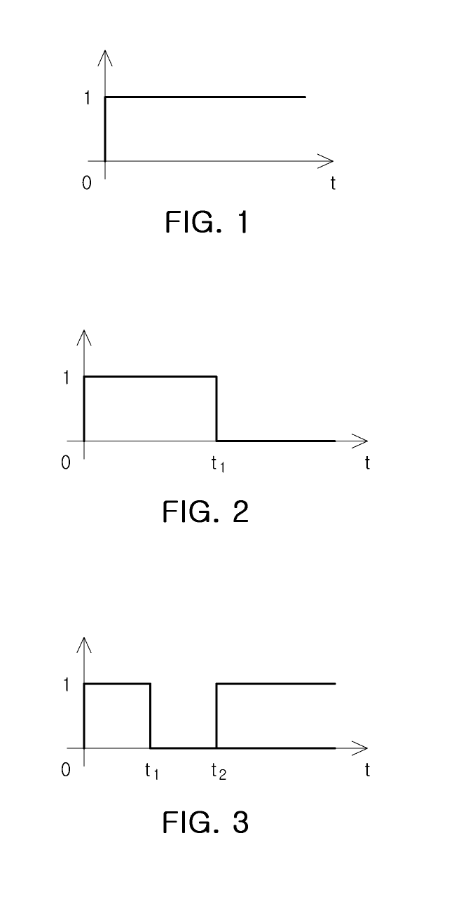

FIG. 1 shows a general unit step signal. When an input signal is the unit-step signal as shown in FIG. 1, that is, when U(s)=1/s, a response (Y(s)) of a system may be represented by Mathematical Equation 3.

$$Y ( s ) = \frac{{ω}_{n}^{2}}{( {s}^{2} + 2 ζ {ω}_{n} s + {ω}_{n}^{2} ) s} \qquad [ Mathematical Equation 3 ]$$

Mathematical Equation 3 may be replaced by Mathematical Equation 4 in order to facilitate inverse Laplace transform.

$$\begin{matrix}Y ( s ) = \frac{1}{s} - \frac{s + 2 ζ {ω}_{n}}{( {s}^{2} + 2 ζ {ω}_{n} s + {ω}_{n}^{2} )} \\ = \frac{1}{s} - \frac{s + ζ {ω}_{n}}{{( s + ζ {ω}_{n} )}^{2} + {ω}_{d}^{2}} - \\ \frac{{ζω}_{n}}{{( s + ζ {ω}_{n} )}^{2} + {ω}_{d}^{2}}\end{matrix} \qquad [ Mathematical Equation 4 ]$$

The response (y(t)) of the system to the unit step input may be represented by Mathematical Equation 5 using the inverse Laplace transform formula.

$${L}^{- 1} [ \frac{s + {ζω}_{n}}{{( s + {ζω}_{n} )}^{2} + {ω}_{d}^{2}} ] = \text{?} cos {ω}_{d} t \\ {L}^{- 1} [ \frac{{ω}_{d}}{{( s + {ζω}_{n} )}^{2} + {ω}_{d}^{2}} ] = \text{?} sin {ω}_{d} t \\ \text{?} \text{indicates text missing or illegible when filed} \qquad [ Mathematical Equation 5 ]$$

Therefore, the response to the unit step may be represented by Mathematical Equation 6.

$$[ Mathematical Equation 6 ]$$

$$\begin{matrix} \begin{matrix}{L}^{- 1} [ Y ( s ) ] = y ( t ) \\ = 1 - \text{?} ( cos {ω}_{d} t + \frac{ζ}{\sqrt{1 - {ζ}^{2}} } sin {ω}_{d} t ) , \\ t \geq 0\end{matrix} & \\ \text{?} \text{indicates text missing or illegible when filed} & \end{matrix}$$

Here, an error signal means residual vibrations and is represented by Mathematical Equation 7.

$$\begin{matrix} \begin{matrix}e ( t ) = r ( t ) - y ( t ) \\ = \text{?} ( cos {ω}_{d} t + \frac{ζ}{\sqrt{1 - {ζ}^{2}}} sin {ω}_{d} t ) , \\ t \geq 0\end{matrix} & [ Mathematical Equation 7 ] \\ \text{?} \text{indicates text missing or illegible when filed} & \end{matrix}$$

As a result, a ringing phenomenon of the voice coil motor may be suppressed by suppressing the error signal.

FIG. 2 shows a general unit gate signal. The unit gate signal may be defined by Mathematical Equation 8.

$$g ( t ) = \{ \begin{matrix}1 , & for 0 \leq {t}_{1} \\ 0 , & for {t}_{1} < 0 , {t}_{1} < t\end{matrix} \qquad [ Mathematical Equation 8 ]$$

As such, the unit gate signal may be represented by the sum of two unit step signals having the same magnitude and opposite signs. The unit gate signal shown in FIG. 2 may be the sum of unit step signals in which a positive step function is applied at t=0 and a negative step function is applied at t=t₁.

Therefore, this may be represented by Mathematical Equation 9.

g(t)=u(t)−u(t−t₁) [Mathematical Equation 9]

According to an exemplary embodiment of the present disclosure, a driving signal may be generated using a combined pulse signal. The combined pulse signal may have a form of a function having a predetermined value until any point in time t₁, having 0 from the point in time t₁ to a point in time t₂, and again having the predetermined value after the point in time t₂. FIG. 3 shows an example of a combined pulse signal.

The combined pulse signal may be represented by Mathematical Equation 10.

f(t)=g(t)+u(t−t₂)=u(t)−u(t−t₁)+u(t−t₂) [Mathematical Equation 10]

Therefore, a system response of a composite signal input may be represented by Mathematical Equation 11 by a principle of superposition.

$$[ Mathematical Equation 11 ]$$

$$x ( t ) = [ 1 - \text{?} ( cos {ω}_{d} t + \frac{ζ}{\sqrt{1 - {ζ}^{2}}} sin {ω}_{d} t ) ] u ( t ) - [ 1 - \text{?} ( cos {ω}_{d} ( t - {t}_{1} ) + \frac{ζ}{\sqrt{1 - {ζ}^{2}}} sin {ω}_{d} ( t - {t}_{1} ) ) ] u ( t - {t}_{1} ) + [ 1 - \text{?} ( cos {ω}_{d} ( t - {t}_{2} ) + \frac{ζ}{\sqrt{1 - {ζ}^{2}}} sin {ω}_{d} ( t - {t}_{2} ) ) ] u ( t - {t}_{2} ) \\ \text{?} \text{indicates text missing or illegible when filed} \qquad$$

Total residual vibrations of the system response may be represented by the sum of residual vibrations of three step inputs as represented by Mathematical Equation 12.

$$[ Mathematical Equation 12 ]$$

$$E ( t ) = [ \text{?} ( cos {ω}_{d} t + \frac{ζ}{\sqrt{1 - {ζ}^{2}}} sin {ω}_{d} t ) ] u ( t ) - [ \text{?} ( cos {ω}_{d} ( t - {t}_{1} ) + \frac{ζ}{\sqrt{1 - {ζ}^{2}}} sin \text{?} [ \text{?} ( cos {ω}_{d} ( t - {t}_{2} ) + \frac{ζ}{\sqrt{1 - {ζ}^{2}}} sin {ω}_{d} ( t - {t}_{2} ) ) ] u ( t - {t}_{2} ) \\ \text{?} \text{indicates text missing or illegible when filed}$$

This may also be represented by Mathematical Equation 13.

E(t)=e(t)u(t)−e(t−t₁)u(t−t₁)+e(t−t₂)u(t−t₂) [Mathematical Equation 13]

Therefore, in order to remove a ringing phenomenon, that is, total residual vibrations, of the system response,

Mathematical Equation 14 needs to be satisfied.

$$[ Mathematical Equation 14 ] \\ [ \text{?} cos {ω}_{d} t ] u ( t ) - [ \text{?} cos {ω}_{d} ( t - {t}_{1} ) ] u ( t - {t}_{1} ) + [ \text{?} cos {ω}_{d} ( t - {t}_{2} ) ] u ( t - {t}_{2} ) = 0 \\ [ \text{?} \frac{ζ}{\sqrt{1 - {ζ}^{2}}} sin {ω}_{d} t ] u ( t ) - [ \text{?} \frac{ζ}{\sqrt{1 - {ζ}^{2}}} sin {ω}_{d} ( t - {t}_{1} ) ] u ( t - {t}_{1} ) + [ \text{?} \frac{ζ}{\sqrt{1 - {ζ}^{2}}} sin {ω}_{d} ( t - {t}_{2} ) ] u ( t - {t}_{2} ) = 0 \\ \text{?} \text{indicates text missing or illegible when filed}$$

Mathematical Equation may be represented by Mathematical Equation 15 in an undamped case (ζ=0).

cos ω_{d}t−cos ω_{d}(t−t₁)+cos ω_{d}(t−t₂)=0 [Mathematical Equation 15]

Here, when t=0, Mathematical Equation may be satisfied.

cos ω_{d}t₁−cos ω_{d}t₂=1 [Mathematical Equation 16]

In addition, when (πn/2)/(wd) is substituted into t, Mathematical Equation 17 may be satisfied.

sin ω_{d}t₁−sin ω_{d}t₂=0 [Mathematical Equation 17]

When Mathematical Equation 17 is arranged, Mathematical Equation 18 may be derived, and when two Mathematical Equations are squared and then arranged, Mathematical Equation 19 may be derived. Then, when two Mathematical Equations are added and then arranged, Mathematical Equation 20 may be obtained.

cos ω_{d}t₁−cos ω_{d}t₂=1

sin ω_{d}t₁−sin ω_{d}t₂=0 [Mathematical Equation 18]

cos² ω_{d}t₁−2 cos ω_{d}t₁ cos ω_{d}t₂−cos² ω_{d}t₂=1

sin² ω_{d}t₁−2 sin ω_{d}t₁ sin ω_{d}t₂−sin² ω_{d}t₂=0 [Mathematical Equation 19]

1−2(cos ω_{d}t₁ cos ω_{d}t₂+sin ω_{d}t₁ sin ω_{d}t₂)+1=1

1−2 cos ω_{d}(t₁−t₂)=0

cos ωd(t₁−t₂)=½ [Mathematical Equation 20]

Therefore, Mathematical Equation 21 may be derived from the above Mathematical Equation.

ω_{d}(t₁−t₂)=−π/3(∵t₁<t₂) [Mathematical Equation 21]

When ω_{d}t₁=ω_{d}t₂−π/3 is substituted into Mathematical Equation 21, Mathematical Equation 22 may be derived.

cos(ω_{d}t₂−π/3)−cos ω_{d}t₂=1

sin(ω_{d}t₂−π/3)−sin ω_{d}t₂=0 [Mathematical Equation 22]

When a first equation of Mathematical Equation 22 is arranged, Mathematical Equation 23 may be derived, and when a second equation of Mathematical Equation 22 is arranged, Mathematical Equation 24 may be derived. In addition, when Mathematical Equations 23 and 24 are arranged, Mathematical Equation 25 may be obtained.

cos ω_{d}t₂ cos π/3+sin ω_{d}t₂ sin π/3−cos ω_{d}t₂=1

½ cos ω_{d}t₂+\sqrt{3}/2 sin ω_{d}t₂−cos ω_{d}t₂=1 [Mathematical Equation 23]

sin ω_{d}t₂ cos π/3+cos ω_{d}t₂ sin π/3−sin ω_{d}t₂=0

½ sin ω_{d}t₂+\sqrt{3}/2 cos ω_{d}t₂−sin ω_{d}t₂=1 [Mathematical Equation 24]

½ cos ω_{d}t₂+\sqrt{3}/2 sin ω_{d}t₂=1

\sqrt{3}/2 cos ω_{d}t₂−½ sin ω_{d}t₂=0 [Mathematical Equation 25]

Mathematical Equation 26 may be obtained from a second equation of Mathematical Equation 25, and when Mathematical Equation 26 is substituted into a first equation of Mathematical Equation 25 and then arranged, Mathematical Equation 27 may be obtained.

$$\begin{matrix} sin {ω}_{a} {t}_{2} = \sqrt{3} cos {ω}_{a} {t}_{2} & [ Mathematical Equation 26 ] \\ 1 \text{/} 2 cos {ω}_{a} {t}_{2} + \sqrt{3} \text{/} 2 \sqrt{3} cos {ω}_{a} {t}_{2} = 1 \\ 1 \text{/} 2 cos {ω}_{a} {t}_{2} + 3 \text{/} 2 cos {ω}_{a} {t}_{2} = 1 \\ 2 cos {ω}_{a} {t}_{2} = 1 \\ cos {ω}_{a} {t}_{2} = 1 \text{/} 2 & [ Mathematical Equation 27 ]\end{matrix}$$

As a result, Mathematical Equation 28 may be derived from Mathematical Equation 27.

$${ω}_{a} {t}_{2} = 2 π \text{/} 3 \\ {ω}_{a} {t}_{1} = {ω}_{a} {t}_{2} - π \text{/} 3 \\ {ω}_{a} {t}_{1} = 2 π \text{/} 3 - π \text{/} 3 = π \text{/} 3 \qquad [ Mathematical Equation 28 ]$$

When the above equations are arranged, in the case in which the composite signal is used as the driving signal, the residual vibrations of the entire system response may be represented by Mathematical Equation 29.

E(t)=e(t)u(t)−e(t−t₁)u(t−t₁)+e(t−t₂)u(t−t₂) [Mathematical Equation 29]

Therefore, a case in which residual vibrations become 0 in the undamped case (ζ=0) may be represented by Mathematical Equation 30.

$${t}_{1} = \frac{π / 3}{{ω}_{d}} , \\ {t}_{2} = \frac{\frac{2 π}{3}}{{ω}_{d}} \qquad [ Mathematical Equation 30 ]$$

Meanwhile, in the damped case (0<ζ<1) rather than the undamped case, a condition under which the residual vibrations become 0 may be changed depending on the damping ratio of the system.

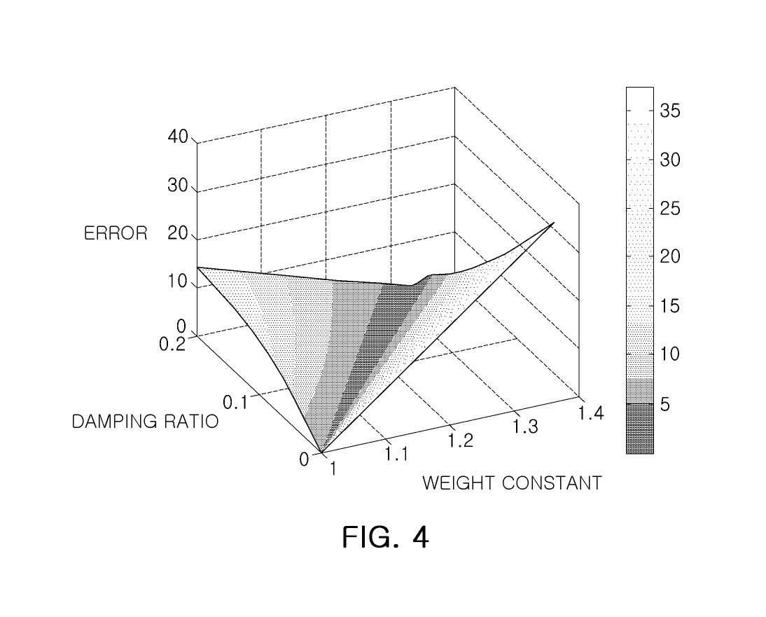

FIG. 4 is a graph showing a change amount of residual vibrations depending on a change in a damping ratio and a weight of a pulse width. FIG. 4 shows the case in which the damping ratio is changed from 0.0 to 0.2 and the weight of the pulse width is changed from 1.0 to 1.4.

As shown in FIG. 4, as the damping ratio is increased from 0.0 to 0.2, a weight value for significantly decreasing the residual vibrations may be monotonously increased. That is, when the damping ratio is increased, a weight applied to a pulse, that is, a driving signal, may be monotonously increased.

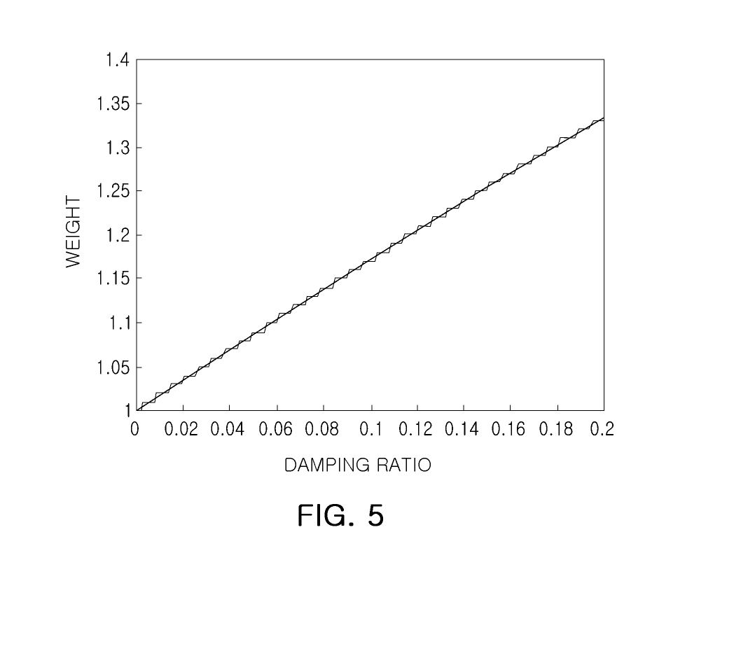

FIG. 5 is a reference diagram showing a change in a weight to a damping ratio given in FIG. 4. That is, the weight that may significantly decrease an error depending on the damping ratio is denoted by a blue line, and a fitted graph is denoted by a red line.

As shown in FIG. 5, the weight may be 1 when the damping ratio is 0 and may be increased by approximately 30% when the damping ratio is increased to 0.18.

As described above, according to an exemplary embodiment of the present disclosure, an optimal weight may be calculated using a fitting function depending on the damping ratio of the voice coil motor. Hereinafter, various exemplary embodiments of the present disclosure will be described based on the above-mentioned mathematical background.

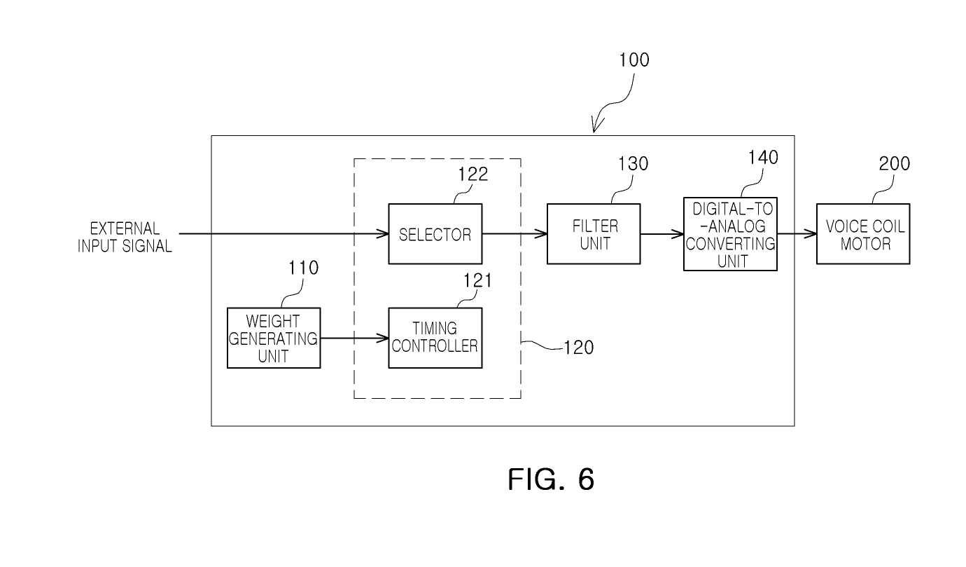

FIG. 6 is a configuration diagram showing an example of a voice coil motor system according to an exemplary embodiment of the present disclosure.

The voice coil motor system may include a voice coil motor apparatus 200 and a motor driving apparatus 100.

The motor driving apparatus 100 may generate a driving signal using a damping ratio of the voice coil motor apparatus 200.

In an exemplary embodiment of the present disclosure, the driving signal may be generated by reflecting weights generated using the damping ratio in external input signals (for example, set codes). For example, in the case in which the driving signal is the above-mentioned composite signal, in an exemplary embodiment of the present disclosure, the driving signal may be generated by converting values of at least some signals among the external input signals to 0 using the weight by the weight body, such that a ringing phenomenon of the voice coil motor may be decreased.

In an exemplary embodiment of the present disclosure, the motor driving apparatus 100 may include a weight generating unit 110 and a driving signal generating unit 120. In an exemplary embodiment of the present disclosure, the motor driving apparatus 100 may further include at least one of a filter unit 130 and a digital-to-analog converting unit 140.

The weight generating unit 110 may generate weights of the external input signals using a damping ratio of a motor apparatus (voice coil motor apparatus in an example shown in FIG. 6). Here, the weight has been described above with reference to Mathematical Equations and FIGS. 4 and 5.

In an exemplary embodiment of the present disclosure, the weight generating unit 110 may generate the weight per each period of the driving signal.

In an exemplary embodiment of the present disclosure, the weight generating unit 110 may generate the weight using Mathematical Equation 31.

α=p(1)*zeta³+p(2)*zeta²+p(3)*zeta+p(4) [Mathematical Equation 31]

Here, zeta is a damping ratio, and p(1) to p(4) indicate fitting coefficients.

The generated weight may be provided to the driving signal generating unit 120, and the driving signal generating unit 120 may generate the driving signal using the weight.

The driving signal generating unit 120 may generate the driving signal by converting values of at least some signals among the external input signals to 0 using the weights.

In an exemplary embodiment of the present disclosure, the driving signal may include a first signal outputting a predetermined value until a first time, a second signal outputting 0 from the first time to a second time, and a third signal outputting the predetermined value after the second time.

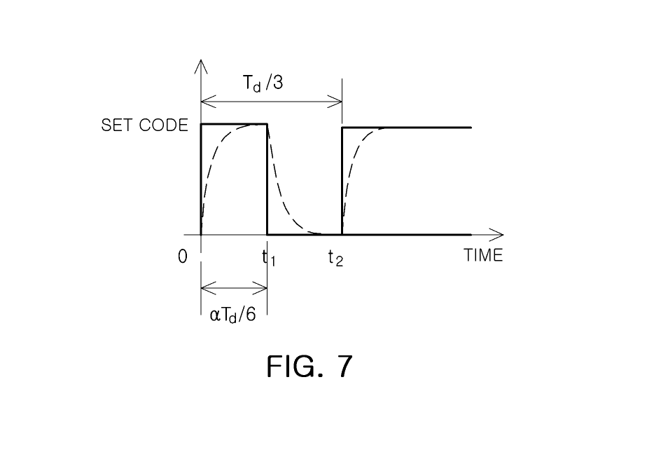

FIG. 7 is a reference diagram showing an example of a driving signal output from a driving signal generating unit 120 of FIG. 6. In FIG. 7, a solid line is an output of the driving signal generating unit 120, and a dotted line is an output of the filter unit 130.

Referring to FIG. 7, the driving signal generating unit 120 may output the external input signal (set code) (corresponding to the first signal) from 0 to the first time t₁ and output 0 (corresponding to the second signal) from the first time t₁ to the second time t₂. The driving signal generating unit 120 may again output the external input signal (corresponding to the third signal) after the second time t₂.

Here, it may be appreciated that the driving signal generating unit 120 determines the first time using a weight α. As a result, the driving signal generating unit 120 may set some signals among the external input signals to 0 at a predetermined point in time depending on the damping ratio of the voice coil motor apparatus 200 to offset vibrations of the voice coil motor apparatus 200, thereby preventing a ringing phenomenon.

In an exemplary embodiment of the present disclosure, the driving signal generating unit 120 may include a timing controller 121 and a selector 122.

The timing controller 121 may reflect the weight in the external input signal and determine output timing of the second signal using the weight provided from the weight generating unit 110.

In an exemplary embodiment of the present disclosure, as shown in FIG. 7, the timing controller 121 may reflect the weight at a point in time corresponding to ⅙ of a resonance period of the motor apparatus to determine the first time and may determine a point in time corresponding to ⅓ of the resonance period of the motor apparatus to be the second time. It may be obvious that coefficients (⅓ and ⅙) becoming references of the first and second times may be varied depending on other exemplary embodiments of the present disclosure.

The selector 122 may output the driving signal including the first to third signals based on the control of the timing controller.

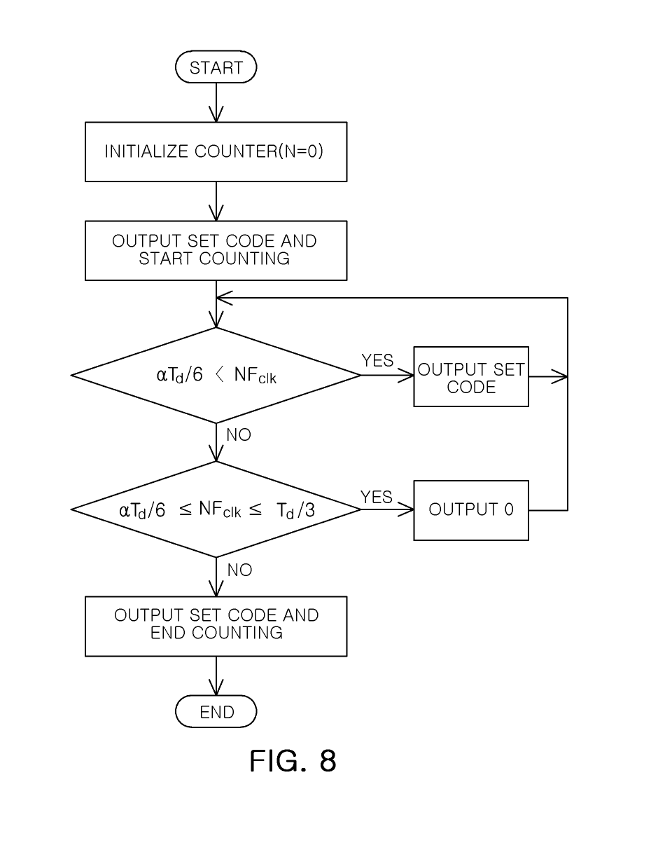

FIG. 8 is a reference diagram for describing an operation of a timing controller based on an example of FIG. 7.

Referring to FIG. 8, when an operation starts, the timing controller 121 may first initialize a counter and output the external input signal (set code). Then, the timing controller 121 may repeatedly confirm whether the first time t₁ and the second time t₂ have been generated.

The timing controller 121 may perform a control to output the external input signal (set code) in the case in which α*Td/6<N*Fclk. The timing controller 121 may perform a control to output 0 in the case in which α*Td/6=N*Fclk=Td/3 and may perform a control to again output the external input signal (set code in the case in which Td/3<N*Fclk. Here, N is a counter coefficient, and Fclk is a frequency of a clock of the counter.

Again referring to FIG. 6, the filter unit 130 may low-pass-filter the driving signal output from the driving signal generating unit 120.

The filter unit 130 may include a low pass filter (LPF) that may shape the driving signal. As an example, the filter unit 130 may be implemented by a 1st infinite impulse response (IIR) filter.

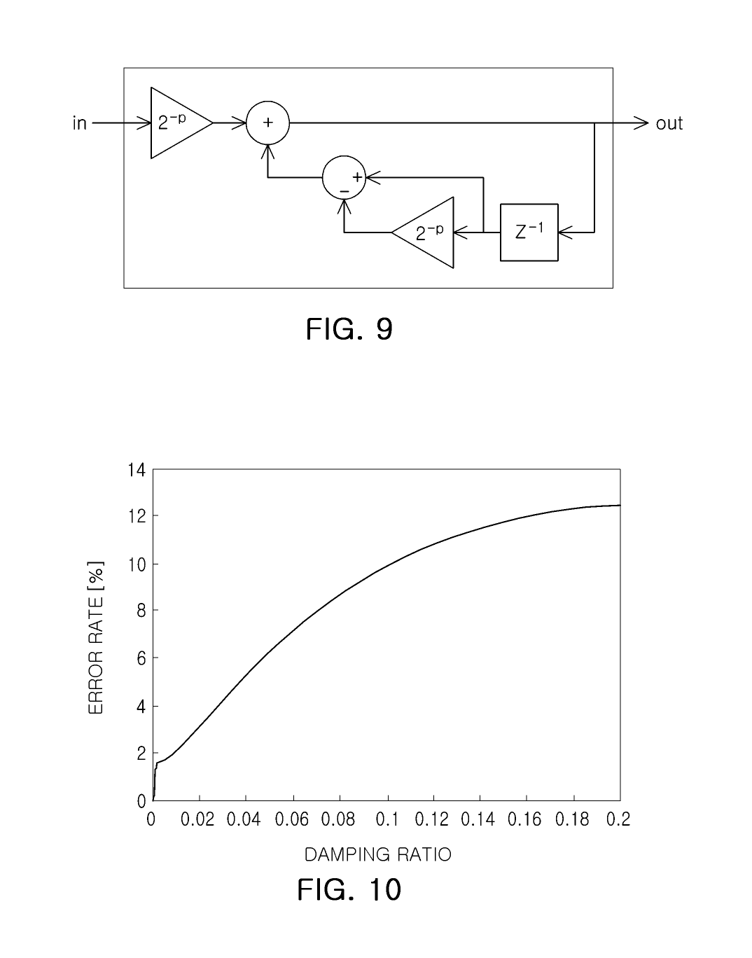

FIG. 9 is a reference diagram showing an example of a filter unit of FIG. 6.

Here, a transfer function of a filter may be represented by Mathematical Equation 32.

$$H ( z ) = \frac{{2}^{- P}}{1 - ( 1 - {2}^{- P} ) {z}^{- 1}} \qquad [ Mathematical Equation 32 ]$$

This may be represented by Mathematical Equation 33, which is a difference equation.

y(n)=(1−2^{̂-P})*y(n−1)+2^{̂-P}*x(n) [Mathematical Equation 33]

In addition, an effective cut-off frequency of the filter may be represented by Mathematical Equation 34.

$$\text{?} = \frac{{2}^{- P}}{2 π} \text{?} {F}_{s} \\ \text{?} \text{indicates text missing or illegible when filed} \qquad [ Mathematical Equation 34 ]$$

Here, Fₛ is a sampling frequency.

The digital-to-analog converting unit 140 may perform digital-to-analog conversion on the driving signal and provide the converted signal to the voice coil motor apparatus.

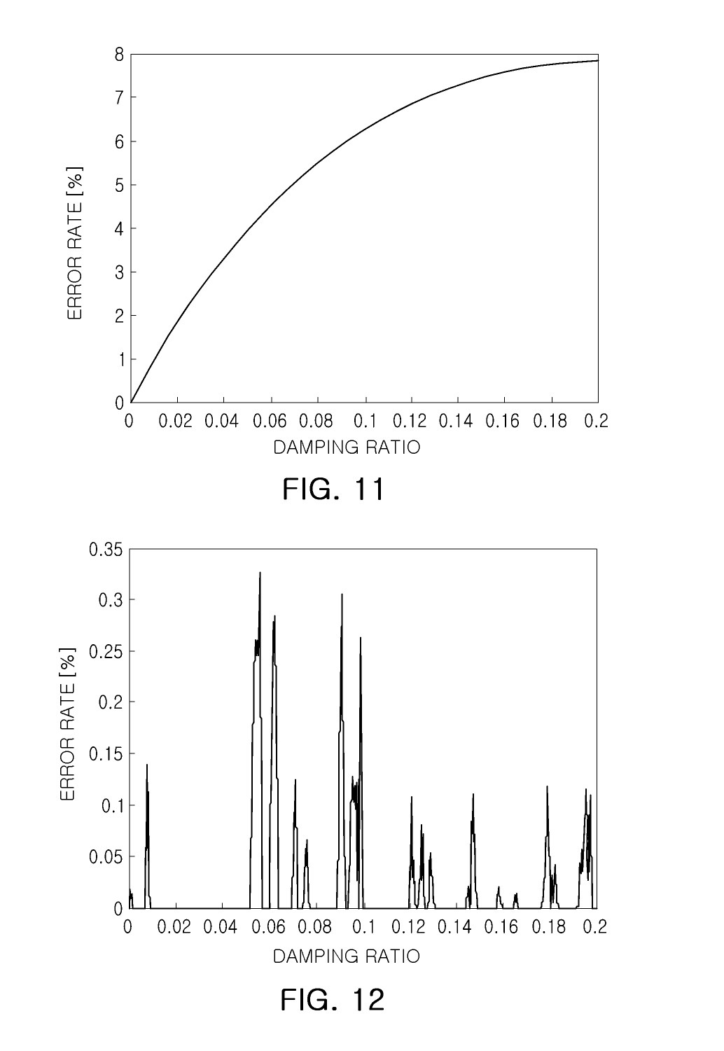

FIGS. 10 and 11 are reference graphs showing a vibration error according to the related art; and FIG. 12 is a reference graph showing a vibration error according to an exemplary embodiment of the present disclosure.

FIG. 10 shows an error of residual vibrations in the case in which a 2-step driving signal is applied. It may be seen from FIG. 10 that an error of 12% or more occurs as a damping ratio is increased.

FIG. 11 shows performance for a linear driving signal scheme. It may be seen from FIG. 11 that an error is decreased as compared with FIG. 10; however, an error of about 8% occurs as a damping ratio is increased.

FIG. 12 shows performance according to an exemplary embodiment of the present disclosure. It may be appreciated that an error has been significantly decreased in an exemplary embodiment of the present disclosure as compared with schemes according to the related art. The reason is that the residual vibrations are significantly decreased by controlling a step magnitude (amplitude) of an applied pulse depending on the damping ratio of the voice coil motor in an exemplary embodiment of the present disclosure. That is, the reason is that an exemplary embodiment of the present disclosure has a feature that vibrations are significantly decreased by outputting at least some signals among the external input signals (set codes) as 0 so that the residual vibrations are offset.

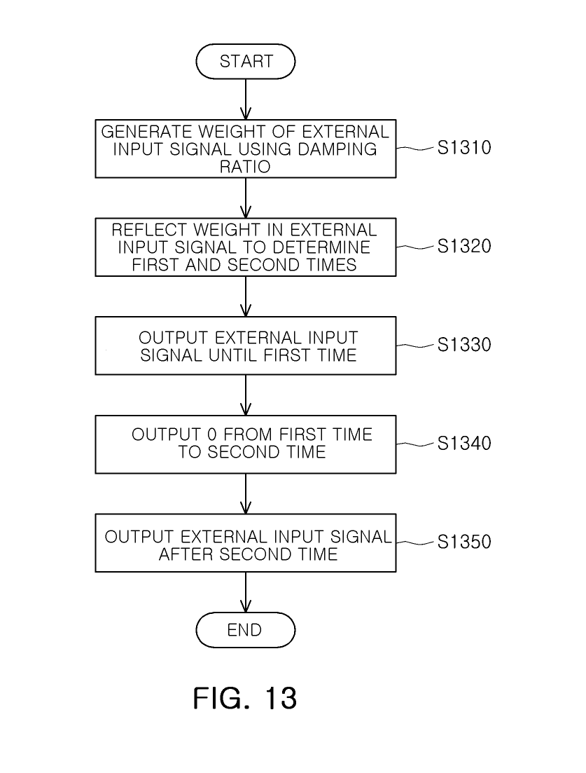

FIG. 13 is a flow chart for describing an example of a motor driving method according to an exemplary embodiment of the present disclosure.

Since a motor driving method to be described below with reference to FIG. 13 is performed by the motor driving apparatus described above with reference to FIGS. 1 through 12, a description that is the same as or corresponds to the above-mentioned description will be omitted.

Referring to FIG. 13, the motor driving apparatus 100 may generate the weights of the external input signals using the damping ratio of the motor apparatus (S1310).

Then, the motor driving apparatus 100 may generate the driving signal by converting values of at least some signals among the external input signals to 0 using the weights (S1320 through S1350).

In an exemplary embodiment of the present disclosure, the motor driving apparatus 100 may reflect the weight at the point in time corresponding to ⅙ of the resonance period of the motor apparatus to determine the first time and may determine the point in time corresponding to ⅓ of the resonance period of the motor apparatus to be the second time (S1320). Then, the motor driving apparatus 100 may output a value corresponding to the external input signal until the first time (S1330) and output 0 from the first time to the second time (S1340). The motor driving apparatus 100 may output a value corresponding to the external input signal after the second time (S1350).

The above-mentioned the driving signal may include the first signal outputting the predetermined value until the first time, the second signal outputting 0 from the first time to the second time, and the third signal outputting the predetermined value after the second time.

In an example of S1310, the motor driving apparatus 100 may calculate the weight α using the following Equation.

α=p(1)*zeta³+p(2)*zeta²+p(3)*zeta+p(4);

Here, zeta is the damping ratio, and p(1) to p(4) indicate the fitting coefficients.

As set forth above, according to exemplary embodiments of the present disclosure, the driving signal is generated by reflecting the weight using the damping ratio of the motor apparatus to prevent a resonance phenomenon of the voice coil motor and a ringing phenomenon due to the resonance phenomenon, whereby the driving of the voice coil motor may be more accurately controlled.

While exemplary embodiments have been shown and described above, it will be apparent to those skilled in the art that modifications and variations could be made without departing from the spirit and scope of the present disclosure as defined by the appended claims.

What is claimed is:

1. A motor driving apparatus comprising:
a weight generating unit generating weights of external input signals using a damping ratio of a motor apparatus; and
a driving signal generating unit generating a driving signal by converting values of at least some signals among the external input signals to 0 using the weights.

2. The motor driving apparatus of claim 1, wherein the weight generating unit calculates the weight α using the following Equation:
α=p(1)*zeta³+p(2)*zeta²+p(3)*zeta+p(4)
where zeta is the damping ratio, and p(1) to p(4) indicate fitting coefficients.

3. The motor driving apparatus of claim 1, wherein the driving signal includes a first signal outputting a first value until a first time, a second signal outputting 0 from the first time to a second time, and a third signal outputting the first value after the second time.

4. The motor driving apparatus of claim 3, wherein the driving signal generating unit includes:
a timing controller determining output timing of the second signal using the weight provided from the weight generating unit; and
a selector outputting the driving signal including the first to third signals based on controlling by the timing controller.

5. The motor driving apparatus of claim 4, wherein the timing controller reflects the weight at a point in time corresponding to ⅙ of a resonance period of the motor apparatus to determine the first time and determines a point in time corresponding to ⅓ of the resonance period of the motor apparatus to be the second time.

6. The motor driving apparatus of claim 1, further comprising a filter unit low-pass-filtering the driving signal output from the driving signal generating unit.

7. The motor driving apparatus of claim 1, wherein the external input signal and the driving signal are digital signals, and
the motor driving apparatus further comprising a digital-to-analog converting unit performing digital-to-analog conversion on the driving signal and providing the converted signal to the motor apparatus.

8. A voice coil motor system comprising:
a voice coil motor apparatus; and
a motor driving apparatus generating a driving signal using a damping ratio of the voice coil motor apparatus,
wherein the driving signal is generated by converting values of at least some of external input signals to 0 using weights generated using the damping ratio.

9. The voice coil motor system of claim 8, wherein the motor driving apparatus includes:
a weight generating unit generating the weights of the external input signals using the damping ratio; and
a driving signal generating unit generating the driving signal by converting values of at least some signals among the external input signals to 0 using the weights.

10. The voice coil motor system of claim 9, wherein the weight generating unit calculates the weight α using the following Equation:
α=p(1)*zeta³+p(2)*zeta²+p(3)*zeta+p(4)
where zeta is the damping ratio, and p(1) to p(4) indicate fitting coefficients.

11. The voice coil motor system of claim 9, wherein the driving signal includes a first signal outputting a first value until a first time, a second signal outputting 0 from the first time to a second time, and a third signal outputting the first value after the second time.

12. The voice coil motor system of claim 11, wherein the driving signal generating unit includes:
a timing controller determining output timing of the second signal using the weight provided from the weight generating unit; and
a selector outputting the driving signal including the first to third signals based on controlling by the timing controller.

13. The voice coil motor system of claim 12, wherein the timing controller reflects the weight at a point in time corresponding to ⅙ of a resonance period of the voice coil motor apparatus to determine the first time and determines a point in time corresponding to ⅓ of the resonance period of the voice coil motor apparatus to be the second time.

14. A motor driving method performed by a motor driving apparatus for driving a motor apparatus, comprising:
generating weights of external input signals using a damping ratio of the motor apparatus; and
generating a driving signal by converting values of at least some signals among the external input signals to 0 using the weights.

15. The motor driving method of claim 14, wherein the driving signal includes a first signal outputting a first value until a first time, a second signal outputting 0 from the first time to a second time, and a third signal outputting the first value after the second time.

16. The motor driving method of claim 15, wherein in the generating of the weights, the weight α is calculated using the following Equation:
α=p(1)*zeta³+p(2)*zeta²+p(3)*zeta+p(4)
where zeta is the damping ratio, and p(1) to p(4) indicate fitting coefficients.

17. The motor driving method of claim 15, wherein the generating of the driving signal includes:
reflecting the weight at a point in time corresponding to ⅙ of a resonance period of the motor apparatus to determine the first time and determining a point in time corresponding to ⅓ of the resonance period of the motor apparatus to be the second time;
outputting a value corresponding to the external input signal until the first time;
outputting 0 from the first time to the second time; and
outputting the value corresponding to the external input signal after the second time.
